(19) United States
(12) Patent Application Publication
(10) Pub. No.: US 2004/0227115 A1
(43) Pub. Date: Nov. 18, 2004

(54) Tap for gas cylinder

(76) Inventors: Paul Kremer, Walferdange (LU); Jacques Schmit, Eppeldorf (LU)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/809,159

(22) Filed: Mar. 25, 2004

(30) Foreign Application Priority Data
Mar. 26, 2003 (EP) 03075884.1

(51) Int. Cl. F16K 31/44

(52) U.S. Cl. 251/77

(57) ABSTRACT

A gas tank valve comprises a wheel handle mounted on a control stem. The wheel handle can be displaced on the control stem in the direction of the longitudinal axis of the stem between a first position, in which the wheel handle is coupled to the stem, with a view to activating it, and a second, uncoupled position, in which the wheel can turn freely on the stem without causing rotational movement of the stem.

### CROSS-REFERENCE TO RELATED APPLICATIONS

This application claims priority to European Application No 03075884.1 filed Mar. 26, 2003.

### STATEMENT REGARDING FEDERALLY SPONSORED RESEARCH OR DEVELOPMENT

Not Applicable.

### BACKGROUND OF THE INVENTION

The present invention involves a valve for a gas tank. The valve features a rotating control stem whose purpose is to activate a device for closing and opening, and a control wheel handle for turning the control stem that opens or closes the valve.

In order to lift and transport a gas tank, the tank is normally grasped by the valve wheel handle, which exposes the user to the risk of accidentally opening the valve and may cause undesirable release of the gas enclosed in the tank.

The purpose of the present invention is to overcome this drawback.

### BRIEF SUMMARY OF THE INVENTION

In order to solve the subject problem of the invention, the gas tank valve of the type indicated above is distinguished by the fact that the control wheel handle is axially mobile on the control stem between a first axial position, in which the control wheel handle and the control stem are coupled together in such a way that a rotational movement of the control wheel handle causes a corresponding rotational movement of the control stem, and a second axial position in which the control wheel handle and control stem are uncoupled from each other, and the wheel can turn freely on the stem without causing any rotational movement of the stem. A snap-on elastic retaining device is provided between the control wheel handle and the control stem which holds the wheel handle in an elastic manner in one or the other of these two positions on the control stem. The control wheel can be axially displaced on the stem between these two axial positions by the application of a predetermined axial force on the wheel with a view to overcoming the retaining force of the elastic retaining device.

The control wheel has a non-circular internal part, preferably hexagonal, and the control stem has an external part of a corresponding geometric shape. In the first wheel position, these two parts are engaged with each other, i.e. the wheel and the stem are mechanically coupled together in order to provide transmission of a rotational movement of the wheel to the stem, and, in the second wheel position, the internal, non-circular part of the wheel is axially disengaged from the external, non-circular part of the stem, i.e. the wheel is uncoupled from the stem and can turn freely on it, thus preventing transmission of a control movement from the wheel to the stem.

According to one embodiment, the snap-on elastic retaining means comprises two circumferential grooves, axially spaced relative to each other, and machined into the external circumferential surface of the stem, and one or more pins lodged in one or more radial holes in the control wheel, and biased radially towards the inside by an elastic ring fitted onto the control wheel so as to hold the wheel elastically in one or the other position on the control stem. The elastic ring is preferably a toric ring, made of elastomeric material and fitted into a circumferential groove that is machined into the external surface of the control wheel.

A stop can be provided in order to limit the axial displacement of the control wheel handle relative to the stem, in both directions, beyond the first axial position and beyond the second axial position. A retaining screw prevents axial separation of the wheel from the control stem.

### BRIEF DESCRIPTION OF THE SEVERAL VIEWS OF THE DRAWINGS

We shall now explain the invention in greater detail, and shall refer to the drawings, in which:

FIG. 1 is an elevational view of the upper part of a gas tank valve, according to the present invention;

FIG. 2 is an enlarged axial sectional view of the upper part of the valve, along lines A-A of FIG. 1, showing the valve wheel coupled to the valve stem;

FIG. 3 is a view similar to FIG. 2 but showing the wheel in its position uncoupled from the valve stem; and

FIG. 4 is a transverse sectional view along lines B-B in FIG. 1.

### DETAILED DESCRIPTION OF THE INVENTION

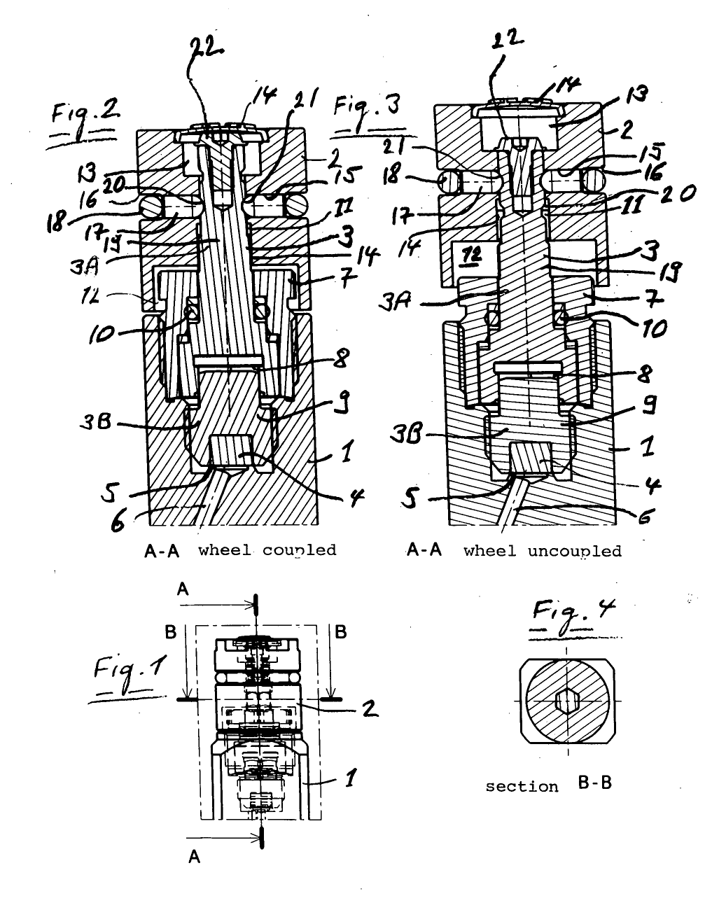

We shall now describe the invention in greater detail with reference to FIGS. 1 through 4. The invention was specifically conceived for a medical gas tank valve, but the invention is not limited to this type of valve and can find applications in any valve that is used to open or close a passage or conduit for gases or liquids.

As shown in FIGS. 2 and 3, the valve comprises a valve body 1 and a control wheel 2 mounted around a control stem 3, which has an upper part 3A and a lower part 3B. The lower part 3B of stem 3 is provided with a valve member 4 which, when the valve is in the closed position, airtightly engages a seat surface 5 of the valve body A. When the valve is in the open position, the valve member 4 is separated from seat surface 5 and the fluid can circulate between a passage 6 of valve body 1 and another body passage (not shown).

Valve control stem 3 is held inside valve body 1 by means of a jointing 7, which is screwed into a tapped bore in valve body 1. Upper part 3A of valve control stem 3 is provided at its lower end with a square opening 8, which engages a square upper part 9 of lower part 3B of valve control stem 3. For rotation purposes, upper part 3A of valve control stem 3 is set inside jointing 7 and an airtight sealing ring 10 is provided between upper part 3A of control stem 3 and jointing 7. Lower part 3B of control stem 3 is screwed into another tapped bore of valve body 1. It is understood that by applying a rotational movement to control stem 3 in one direction or the other seat packing 4 can be shifted in one direction or the other relative to seat surface 5 of valve body 1 to open or close the valve.

Control stem 3 can be turned in one direction or the other using control wheel 2, whose shape is generally cylindrical and which is provided with a longitudinal central passage 11 of different diameters.

Longitudinal central passage 11 features a large-diameter counter-bore at its lower end, which forms a smaller cavity 12 which surrounds an upper part of jointing 7. At its upper end, central passage 11 has a counter-bore of smaller diameter, which forms an upper cavity 13 that is closed by a protective cap 14 made of plastic material.

Between the two counter-bores 12 and 13, central longitudinal passage 11 has a part 14 that is non-circular in shape, preferably hexagonal, just above lower cavity 12. The rest of central longitudinal passage 11, which extends into the non-circular part 14, towards and up to upper cavity 13, is cylindrical. One or more radial holes 15 are made in control wheel 2, above the non-circular upper part 14 and which open into the interior of the cylindrical part of the central longitudinal passage 11 below the upper cavity 13 and an exterior circumferential groove 16 machined into the external circumferential surface of control wheel 2.

In each radial hole 15, there is a radial pin 17 which is biased radially towards the inside, using an elastic ring 18, preferably a toric ring of elastomeric material, and which fits into circumferential groove 16 in wheel 2.

The control wheel is mounted on the upper part 3A of control stem 3. The upper part 3A of the control stem 3 is provided with a non-circular external surface part 19, preferably hexagonal, which is of geometric shape corresponding to the geometric shape of the non-circular internal part 14 of control wheel 2. Between the non-circular internal part 14 and the upper cavity 13, the internal diameter of the longitudinal central passage is approximately equal to or slightly larger than the external diameter of the control stem 3, above the non-circular external part 19. Above its hexagonal shape part 19, upper part 3A of control stem 3 is generally cylindrical up to its upper end. This cylindrical part is provided with two circumferential grooves 20 and 21, which are separated from each other longitudinally along stem 3.

A screw 22 is engaged in the upper end of upper part 3A of the control stem 3, and the head of this screw 22 features a flange that extends radially beyond an external diameter of the upper end of upper part 3A of control stem 3 and the external diameter of this flange is larger than the internal diameter of the longitudinal central passage 11 in proximity to the upper cavity 13.

The valve operates as follows: control wheel 2 is first in its lower position (FIGS. 1, 2 and 4) in which the internal, non-circular part 14 of control wheel 2 is engaged on, and surrounds, the non-circular external part 19 of the control stem 3, which are therefore mechanically coupled together in order to cause transmission of a rotational motion from wheel 2 to stem 3 that will open or close the valve by rotating control wheel 2. When the control wheel 2 is in its first (lower) position, pins 17 are kept engaged with the lower circumferential groove 20 in stem 3 using the elastic ring 18. The control wheel 2 can be vertically shifted upwards, and axially along the control stem 3 from its first (lower) position towards a second upper position, in which the non-circular internal part 14 of wheel 2 is disengaged from the external non-circular part 19 of control stem 3, as shown in FIG. 3. In this second upper position, pins 17 are kept engaged in the upper groove 21 of the control stem. In this upper position of wheel 2, it can turn freely on the control stem 3 without causing rotational movement of this stem.

Elastic ring 18, radial pins 17 and circumferential grooves 20 and 21 create a means of snap-on elastic retention between wheel 2 and stem 3 with a view to holding wheel 2 elastically in one or the other of the two positions of stem 3, since wheel 2 can be axially displaced on stem 3 between these two axial positions by a predetermined axial force applied to wheel 2 with a view to overcoming the force of the elastic retaining ring 18. The axial displacement of wheel 2 from one of these two positions on stem 3 towards its other position, causes radial disengagement of pins 17 from one of the two grooves 20, 21 against the elastic force of ring 18, and then radial engagement of these pins 17 in the other groove under the effect of the elasticity of ring 18.

A stop is provided in order to limit the axial displacement of wheel 2 on stem 3 in both directions. Shifting of wheel 2 upwards, past the first position, and separation of wheel 2 from control stem 3, is prevented by the radial flange of screw 22, which engages the bottom of upper cavity 13 in the second, upper, non-coupled position of control wheel 2. The axial movement of wheel 2 on control stem 3 in the other, downward direction, beyond the second position, is limited by the engagement of the bottom surface of lower cavity 12 with the upper surface of jointing 7, or else by engaging the lower end of control wheel 2, with the upper end of valve body 1.

The invention is not limited to the manner of execution shown in the attached drawings, and many changes can be made to it without these changes bringing the device away from the scope of the attached claims. A single radial pin 17 can be sufficient to maintain wheel 2 elastically in one or the other of these two positions, but still it is possible to provide two, three or four of these pins 17. The elastic ring, rather than being manufactured of elastomeric material, may be an elastic ring made of metallic wire wound helically. Moreover, instead of pins 17 and elastic ring 18 featured on wheel 2, the elastic snap-on retaining means can be provided on control stem 3 and the pin or pins may be forced by an elastic means towards the outside, with a view to engaging in one or the other of the circumferential grooves formed in the surface of the central longitudinal passage of control wheel 2. Also, screw 22 that forms the stop with a view to holding control wheel 2 onto the control stem 3 can be replaced by a split elastic ring, mounted in a circumferential groove in control stem 3. Other changes can be made by the specialist to the method of embodiment described above.

1. A valve for a gas tank comprising a rotatable control stem capable of activating an element for opening or closing the valve, and a control wheel operable to turn the control stem so as to open or close the valve; the control wheel being axially movable on the control stem between a first axial position in which the control wheel and control stem are coupled together such that rotational movement of the control wheel causes a corresponding rotational movement of the control stem, and a second axial position, in which the control wheel and stem are uncoupled from each other and the wheel can turn freely on the stem without causing any rotational movement of the stem; the valve further including an elastic retainer provided between the wheel and the stem to retain the wheel in an elastic manner in one or the other of the two positions on the stem; the wheel being axially displaceable on the stem between its two axial positions by the application of a predetermined axial force on the wheel sufficient to overcome the retaining force of the elastic retainer.

2. The valve according to claim 1, wherein the control wheel has a non-circular internal part, and the control stem has an external part of corresponding geometric shape; wherein, in the first axial position, the internal part of the wheel is engaged with said external part of the stem so as to cause transmission of a rotational motion from the wheel to the stem, and the two parts are axially disengaged from each other in the second axial position of the wheel handle.

3. The valve according to claim 1, wherein the elastic retainer comprises two circumferential grooves that are separated axially from each other on the external circumferential surface of the stem, and at least one pin mounted in a radial hole in the control wheel; the pin being biased radially inwardly by an elastic ring in the wheel with a view to engaging in one or the other of said grooves to maintain the wheel elastically in one or the other of these axial positions; the axial displacement of the wheel from one of these two positions on the stem towards its other position causing radial disengagement of the pin from one of the two grooves against the elastic force of the ring, and then the radial engagement of the pin in the other groove under the effect of the ring's elasticity.

4. The valve according to claim 3 wherein the radial receiving hole of the pin in the control wheel opens to the exterior in an annular groove present in the external circumference of the wheel, the elastic ring being inserted in said groove.

5. The valve according to claim 3 wherein the elastic ring is a toric ring of elastomeric material.

6. The valve according to claim 3 wherein the valve includes a plurality of said pins; said pins being equidistant from each other in the circumferential direction of the control wheel.

7. The valve according to claim 1 including a stop to limit axial displacement of the wheel on the stem in both directions beyond the first position and beyond the second position.

8. The valve according to claim 1 including a stop to prevent separation of the wheel from the control stem.
